(19) United States
(12) Patent Application Publication
(10) Pub. No.: US 2026/0299127 A1
(43) Pub. Date: Oct. 1, 2026

(54) System and method for filtering sensor data

(71) Applicant: SICK AG, Waldkirch (DE)

(72) Inventor: Ulrich ZWÖLFER, Waldkirch (DE)

(21) Appl. No.: 19/633,069

(22) Filed: Mar. 30, 2026

(30) Foreign Application Priority Data
Apr. 1, 2025 (EP) 25167869.4

(51) Int. Cl. G01S 17/00; G01S 7/4865; G06N 3/065

(52) U.S. Cl. CPC G01S 17/006; G01S 7/4865; G06N 3/065

(57) ABSTRACT

A system for filtering sensor data comprises a sensor, a data processing unit and an evaluation unit. The sensor is configured to transmit transmission signals and to receive reception signals after reflection or remission at an object. The data processing unit is configured to process the reception signals into sensor data and to accumulate the sensor data. The evaluation unit is configured to determine at least one local maximum by means of an analog neural network based on the accumulated sensor data.

The invention relates to a system and a method for filtering sensor data.

In modern sensor technology, the precise measurement of distances and movements of objects can be of crucial importance. Conventional sensor technologies reach their limits, in particular when processing large volumes of data that are produced by a reflection or remission of signals.

A known method for distance measurement is the time-of-flight principle in which the time is measured that is required by a transmitted signal to be reflected by an object and to return to the receiver. In this respect, it is often a challenge to efficiently process the received signals and to extract accurate distance data, in particular in environments with a lot of background noise.

It is therefore the object of the present invention to provide an efficient system and method for filtering sensor data.

The object is satisfied by a system for filtering sensor data and by a method for filtering sensor data. Advantageous embodiments of the system and of the method are presented in the dependent claims, in the description and in the drawings.

The system according to the invention serves to filter sensor data. The system comprises a sensor (an optoelectronic sensor), a data processing unit and an evaluation unit. The sensor is configured to transmit transmission signals and to receive reception signals after reflection or remission at an object. The data processing unit is configured to process the reception signals into sensor data and to accumulate the sensor data. The evaluation unit is configured to determine at least one local maximum by means of an analog neural network based on the accumulated sensor data.

The sensor can be a LiDAR sensor. A LiDAR sensor can transmit laser beams, in other words: light beams, and can measure the time required for the light to return to the sensor. The use of a LiDAR sensor can enable a precise distance measurement of objects in the environment of the sensor.

The sensor can comprise a plurality of transmitters and/or receivers. The number of transmitters can be different from the number of receivers.

The data processing unit is configured to receive the reception signals. The reception signals can be amplified by means of the data processing unit to be able to detect even weaker signals more clearly. A noise suppression can then take place in which disruptive background noise or unwanted signals can be filtered out to increase the accuracy of the sensor data.

The sensor data can be collected and combined by means of the data processing unit over a certain time period. This can make it possible to recognize patterns, trends or anomalies in the sensor data in that they can be stored and analyzed in a structured form. The accumulation can in this respect help to smooth the sensor data and to minimize individual outliers, which can lead to a more accurate and reliable analysis of the sensor data. The recognition of patterns, trends or anomalies, in particular of (local) maximum values in the sensor data, can be described as filtering the sensor data.

A local maximum can correspond to a point of the accumulated sensor data that has a higher or greater value compared to the surrounding points of the accumulated sensor data. This point can describe a significant or conspicuous feature, in other words: an anomaly, and can, for example, indicate a specific event or a certain property of the object. Thus, an identification of such local maxima can be used to extract relevant information from the sensor data. For example, based on the determination of a local maximum in the accumulated sensor data, a distance of the object from the sensor can be determined.

An analog neural network can mimic the functioning of a biological neural network, but in an analog form. The analog neural network can comprise a plurality of mutually connected nodes that act as neurons. The neurons can process information, for example, by receiving, weighting and forwarding sensor data. Unlike digital networks, an analog neural network can work continuously with voltages or currents, which can enable a fast and energy-efficient processing of the sensor data. Furthermore, analog neural networks can be particularly suitable for tasks that focus on pattern recognition and decision-making.

In one embodiment, the analog neural network is configured as a correlation filter. A correlation filter, also designated as an optimum filter, can be suitable to optimally filter out a signal from a background noise. The analog neural network can be adapted to determine the at least one local maximum based on accumulated sensor data that comprise interfering signals such as extraneous light. For this purpose, the analog neural network can compare the accumulated sensor data with known reference data and can maximize a match between the sensor data and the reference data. This can enable an efficient recognition of local maximum values in the sensor data, while unwanted noise can be reduced. The analog neural network can effectively differentiate between relevant signal data and noise.

In one embodiment, the analog neural network comprises a plurality of input nodes and a sum node. Each input node of the plurality of input nodes can be configured to receive the sensor data and to forward said data to subsequent layers of the analog neural network. The input nodes can start an initial processing of the sensor data and can, for example, bring the sensor data into a form that is suitable for a further analysis in the analog network. For example, the input nodes can prepare the sensor data for the further processing by converting them into a form that is suitable for an anomaly recognition and analysis in the analog neural network. The conversion of digital sensor data or signals into the analog data or signals required by the analog neural network can preferably take place via one or more digital-to-analog converters (DACs). The sum node can be configured to collect the outputs of the plurality of input nodes. In particular, the sum node can also be configured to process the outputs of the plurality of input nodes and to forward them to one or more (input) nodes of subsequent layers of the analog neural network. It is understood that the analog neural network can also comprise more than one sum node.

In one embodiment, each input node of the plurality of input nodes is configured to receive the sensor data, the accumulated sensor data or a portion of the accumulated sensor data. The plurality of the input nodes can serve as the first layer of the data acquisition in the analog neural network, where the sensor data or accumulated sensor data are fed into the analog neural network. In particular, each input node of the plurality of input nodes can receive the sensor data or the accumulated sensor data of a receiver of the sensor.

In one embodiment, the sum node is configured to perform a weighted summation of the sensor data received via the input nodes or of the accumulated sensor data in order to determine the at least one local maximum. The sum node can perform the weighted summation of the sensor data or the accumulated sensor data in order to generate a combined signal. This signal can represent an overall activation and can in this respect help to recognize patterns in the sensor data or the accumulated sensor data in that the signal combines the contributions of all the input nodes into a unified result. The overall activation can reflect the extent to which the received accumulated and possibly weighted sensor data match a sought pattern or signal. Thus, a precise recognition of patterns, in particular a recognition of local maximum values in the sensor data or accumulated sensor data, can be made possible.

The input nodes and the sum node of the analog neural network can be described by way of example as summing amplifiers (in other words: adders or reverse adders) in analog circuit technology. The summing amplifier can comprise an operational amplifier and resistors. The summing amplifier can take on the function of a weighted adder, wherein the resistors can act as weights by “attenuating” input signals (reception signals) and then summing them. An amplification of the summed reception signals (total signal) can take place by the operational amplifier and a feedback resistor that is arranged between an output of the operational amplifier and a negative input of the operational amplifier.

Specifically, for example, three (or more) input resistors can act as voltage dividers. The three input resistors can determine a ratio with which each reception signal (for example a sensor signal) is attenuated and is conducted as a current to a summing point. The currents of each reception signal can be added at the summing point. The feedback resistor in conjunction with the operational amplifier can amplify the summed current and can generate an output voltage at the output of the operational amplifier. The output voltage can be proportional to the sum of the weighted reception signals.

Thus, due to such a circuit, a desired summing and amplification (or attenuation) of the input signals can be achieved by the combination of voltage dividers and the operational amplifier with a feedback resistor.

In one embodiment, the data processing unit is configured to accumulate the sensor data into a histogram. The histogram can be a graphical representation of the sensor data. The histogram can show how often different values of the sensor data occur within a certain time interval or range. The sensor data can be divided into categories or “bins”, wherein each bin can represent a specific value range, e.g. a time range or a distance range. A bin can be a discrete time interval that can be used to measure the time of flight of light pulses. Each bin can correspond to a specific distance range of the sensor from an object since each bin can represent the time required by the light to travel from the sensor to the object and back. By means of the histogram, patterns or anomalies in the sensor data can be recognized in that the histogram can visualize a distribution and frequency of the recorded measured values or sensor data.

In one embodiment, the histogram is produced by accumulating the sensor data over a predetermined time period, wherein the histogram comprises a frequency count based on the sensor data within the predetermined time period. The frequency count can indicate how often certain values of the sensor data occur within a predefined time frame or time interval. Each bin in the histogram can represent a specific data value range, e.g. a distance of an object from the sensor. The number of data points that fall in this range can be counted and a visual representation of the data distribution can thus be produced. By accumulating the sensor data over a defined time period or at specific time intervals, an improved data analysis can be made possible. Thus, detailed patterns, such as local maxima, can be recognized in the sensor data.

In one embodiment, the histogram is produced by dividing the sensor data into a predetermined number of time intervals, wherein the histogram comprises a frequency count based on the sensor data within the respective time interval. By dividing or segmenting the sensor data into specific time intervals, the system for filtering sensor data can enable a more accurate analysis of the sensor data and thus a more precise recognition of patterns or changes over time.

In one embodiment, the data processing unit comprises the evaluation unit. This can mean that functions of the data processing unit and the evaluation unit, i.e. work steps that are carried out in the data processing unit and in the evaluation unit, are integrated in a common unit, which can increase the efficiency of the signal processing. The integration of the data processing and evaluation unit in a single unit can lead to a faster and more energy-efficient data processing since the sensor data do not have to be transmitted between separate units.

In one embodiment, the data processing unit and the evaluation unit are arranged on a common chip. A compact and efficient circuit that reduces the system size and optimizes the performance can thereby be made possible. The chip integration can furthermore lead to a higher reliability and a lower energy consumption when evaluating the sensor data. The chip can be a time-of-flight (ToF) chip, in particular a direct time-of-flight (dToF) chip.

In one embodiment, the chip has a size in terms of surface area of between 2 mm² and 5 mm², in particular 3 mm².

In one embodiment, the sensor comprises at least one light transmitter for transmitting light transmission signals and at least one light receiver for receiving light reception signals after reflection or remission of the light transmission signals at the object. More precisely, the light of the light transmission signals can therefore be reflected or remitted by an object in the environment of the sensor back to the sensor and can be received there as a light reception signal. The sensor can be suitable for a distance measurement from an object to the sensor. The at least one light transmitter, for example an LED or a laser light source, can transmit light transmission signals into an environment around the sensor. If there is an object in the environment of the sensor, some of the light can be diffusely remitted or reflected and sent back as a remitted light signal or light reception signal to the sensor, where the light reception signals can be received by the at least one light receiver.

The at least one light receiver can comprise a plurality of pixel elements that are each configured as a single-photon avalanche diode (SPAD), also called a Geiger photodiode, and that are preferably arranged in a row or matrix. The term pixel element can refer to individual pixels and not to macropixels that consist of a group of individual pixels.

In one embodiment, the data processing unit is configured to determine a plurality of times of flight between a transmission of the transmission signals and a reception of the reception signals and to accumulate a number of reception signals for each time of flight. The data processing unit can be configured to evaluate SPAD signals and to perform a distance measurement based on the SPAD signals. The plurality of times of flight can be accumulated and evaluated in a histogram by means of the evaluation unit.

The data processing unit can comprise a plurality of time-of-flight measurement devices that are connected to pixel elements to determine a time of flight between the transmission and reception of a light signal. The time-of-flight measurement devices can be configured to determine the plurality of times of flight. The time-of-flight measurement devices can each comprise a TDC (time-to-digital converter).

In one embodiment, the evaluation unit is configured to determine the at least one local maximum by means of the analog neural network based on the number of reception signals for each time of flight. The time of flight can correspond to a distance. The at least one local maximum can indicate a frequent reflection of the transmitted transmission signal or light transmission signals. The at least one local maximum or in general a maximum in the accumulated sensor data can represent a point in time at which the transmission signals reached the object and were reflected back to the sensor.

In one embodiment, the evaluation unit is configured to determine a distance from the object by means of the analog neural network based on the at least one local maximum. By knowing the speed of light and the measured time between the transmission and return of the sensor signals, the distance from the object can be precisely determined. The analog neural network can improve the determination of the distance in that it can identify the maxima efficiently and quickly, which can lead to a more accurate distance determination.

A further aspect of the invention relates to a method for filtering sensor data. The method comprises the following steps: receiving, by means of a sensor, reception signals after reflection or remission at an object; processing, by means of a data processing unit, the reception signals into sensor data; accumulating, by means of the data processing unit, the sensor data; and determining, by means of an evaluation unit, at least one local maximum by means of an analog neural network based on the accumulated sensor data.

In one embodiment, the method further comprises the following steps: transmitting, by means of the sensor, transmission signals; determining a plurality of times of flight between a transmission of the transmission signals and a reception of the reception signals; accumulating, by means of the data processing unit, a number of reception signals for each time of flight; determining, by means of the evaluation unit, the at least one local maximum by means of the analog neural network based on the number of reception signals for each time of flight; and determining, by means of the evaluation unit, a distance from the object by means of the analog neural network based on the at least one local maximum.

The method can comprise training the analog neural network to determine at least one local maximum based on accumulated sensor data. In particular, due to an iterative adaptation process, i.e. the training, the processing of the accumulated sensor data received by the analog neural network can be set so that the analog neural network can effectively learn to recognize relevant features, such as a maximum, in the accumulated sensor data and to make accurate predictions. A training data set for training the analog neural network can comprise sensor data, which have local maxima, and corresponding known output data, for example, the known local maxima of the sensor data.

A further aspect of the invention relates to a vehicle. The vehicle comprises a system for filtering sensor data as described herein. The vehicle can be any kind of vehicle, for example, an autonomously or semi-autonomously driving vehicle. The vehicle comprises at least one system for filtering sensor data as described herein. The vehicle can obtain information about the environment of the vehicle via the sensor and, from this, can determine a distance from possible objects in the environment of the vehicle by means of the system for filtering sensor data. The distances determined by means of the system for filtering sensor data can serve for a control of the vehicle in order, for example, to be able to navigate without collision from a starting point to a target point.

The invention will be described purely by way of example with reference to the drawings in the following. There are shown:

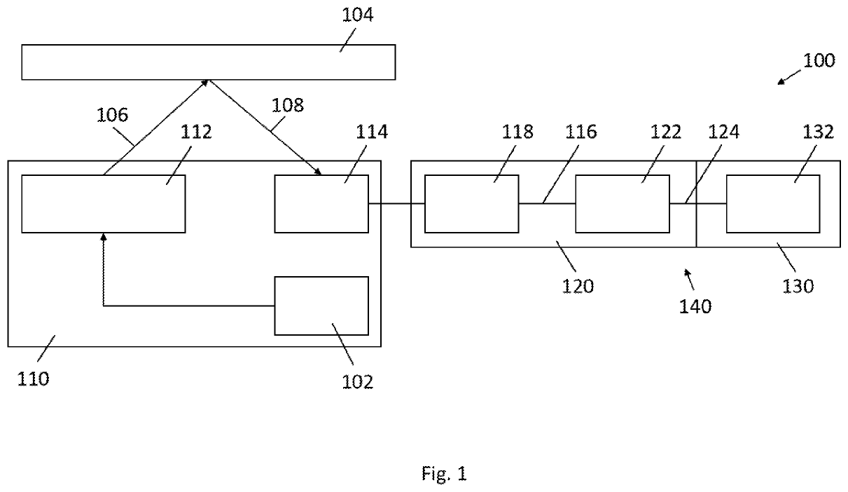

FIG. 1 a schematic representation of a system according to the invention for filtering sensor data according to an embodiment;

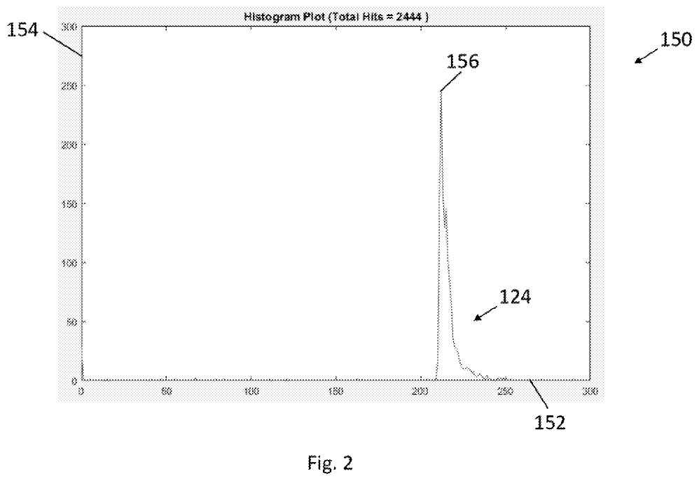

FIG. 2 an Exemplary Representation of Accumulated Sensor Data in a histogram;

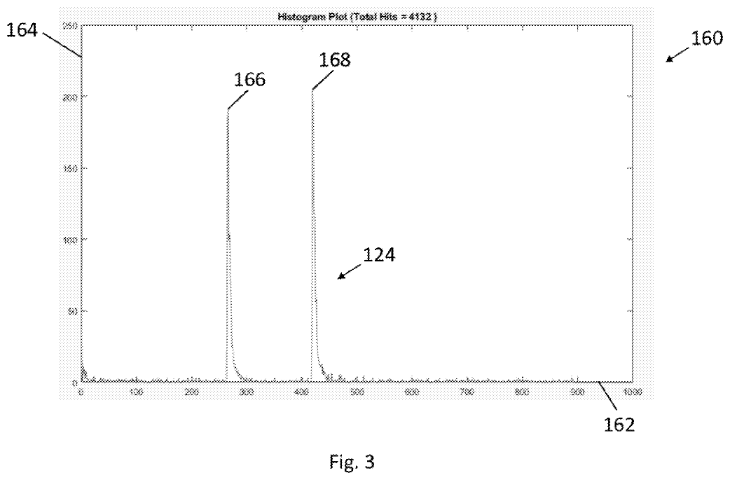

FIG. 3 a further exemplary representation of accumulated sensor data in a histogram;

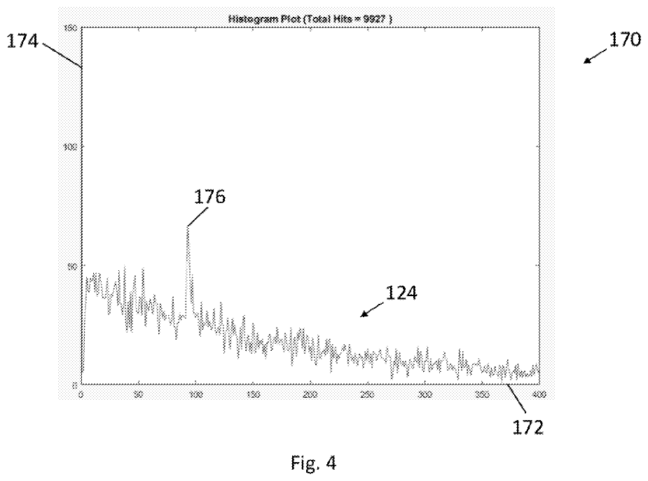

FIG. 4 an Even Further Exemplary Representation of Accumulated Sensor data in a histogram;

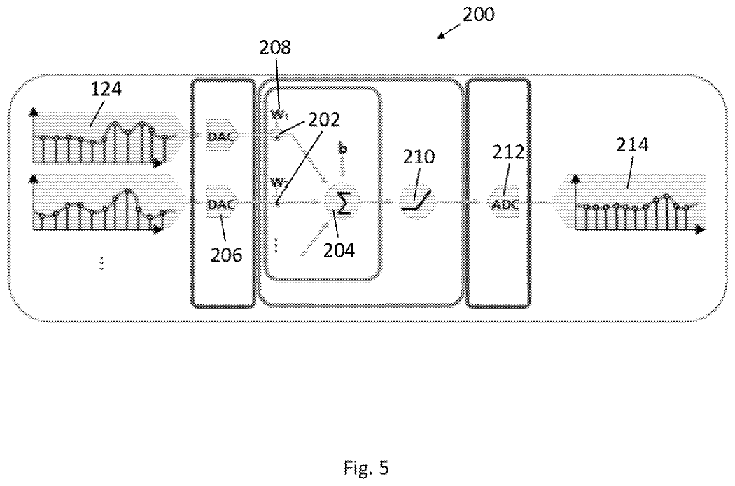

FIG. 5 an exemplary principle representation of an analog neural network; and

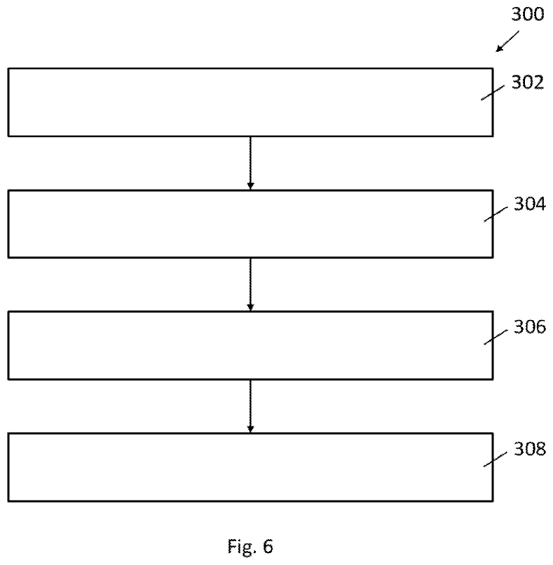

FIG. 6 a flowchart that describes a method for filtering sensor data according to an embodiment.

A low power loss can be important in sensor devices, in particular in small designs. Traditional battery systems or systems with harvesting methods for obtaining energy are often insufficient to perform a local data processing so that sensor data are often wirelessly transmitted to data centers for evaluation. With the help of analog neural networks, a local data evaluation can, however, be made possible directly on the chip, which saves energy and increases data security.

FIG. 1 shows a schematic representation of a system 100 for filtering sensor data 116, in particular for a distance measurement from an object 104 by means of a sensor 110. The system 100 can use the time-of-flight principle to determine a distance of the sensor 110 from the object 104 by measuring the time that is required by transmission signals 106 transmitted by a transmitter 112 of the sensor 110 to travel from the sensor 110 to the object 104 and back to the sensor 110 again, in particular to a receiver 114 of the sensor 110. In particular, a dToF (direct Time-of-Flight) measuring concept for a sensor system can be realized with an architecture and a design as shown in FIG. 1.

A sensor control unit 102 controls the sensor 110. The sensor 110 can be a LiDAR sensor and the transmitter 112 can be configured as a laser. The LiDAR sensor can be a Geiger-mode LiDAR (GmLiDAR) in which a matrix of single-photon-sensitive elements (Geiger-mode Avalanche Photo Diode Array, GmAPD) is illuminated by the reflection of a more divergent laser pulse. The transmitter 112 can also be a light emitting diode (LED).

Accordingly, the transmitter 112 can be a light transmitter that is configured to transmit light signals in the form of light pulses. The transmitter 112 transmits the light signals into a region around the sensor 110. If there is an object 104 in the region, a portion of the light signals can be diffusely remitted or reflected by the object 104 and returned to the sensor 110 as a reception signal 108. The reception signals can be received by the sensor 110, in particular by the receiver 114 of the sensor 110.

The receiver 114 can comprise a plurality of pixel elements. In particular, the receiver 114 can be configured as a “single photon avalanche diode” (SPAD) receiver and can receive the light signals reflected by the object 104. The receiver 114 can comprise a matrix of single-photon-sensitive elements (Geiger-mode Avalanche Photo Diode Array, GmAPD). The receiver 114 can therefore be a light receiver.

The receiver 114 is connected to a data processing unit 120 in which the reception signals 108 can be processed into sensor data 116. The sensor data 116 can be accumulated by means of the data processing unit 120. In particular, the data processing unit 120 can be configured to evaluate signals of the pixel elements of the SPAD receiver to determine a time of flight or a plurality of times of flight between a transmission of the transmission signals 106 and a reception of the reception signals 108. The time of flight can be converted into a distance with the aid of the speed of light.

The data processing unit 120 can comprise a time-to-digital (TDC) converter 118. The TDC converter 118 can measure the time of flight between the transmission of a light signal and the reception of a light signal. In particular, the TDC converter 118 can determine, for each transmission signal 106 and the associated reception signal 108, a time of flight between the transmission of the transmission signal 106 and the reception of the reception signal 108.

The data processing unit 120 can further comprise a histogram unit 122. The histogram unit 122 can be configured to accumulate the sensor data 116 received from the TDC converter 118, in particular the plurality of times of flight. The histogram unit 122 can represent the accumulated sensor data 124 in a histogram. The histogram can describe a distribution of the times of flight, wherein (time) bins can be displayed on an x-axis of the histogram and a number of reception signals 108 that have a time of flight within one of the bins can be represented on a y-axis of the histogram.

The histogram unit 122 can thus create a temporal distribution of the returning reception signals 108. With a sufficiently large number of reception signals 108, the histogram can display a clear peak, i.e. a maximum, from whose position a total time of flight, and thus a distance from the object 104, can be determined. The histogram can comprise more than one peak or maximum, for example, in the case of semi-transparent objects, glass or fog.

The accumulated sensor data 124 can be transmitted from the data processing unit 120 to an evaluation unit 130. The evaluation unit 130 can comprise a microcontroller 132 that can perform an evaluation of the accumulated sensor data 124. The evaluation unit 130 is configured to determine at least one local maximum by means of an analog neural network 200 (see FIG. 5) based on the accumulated sensor data 124. The evaluation unit 130 is in particular configured to determine the at least one local maximum by means of the analog neural network 200. Furthermore, the evaluation unit 130 can be configured to determine a distance from the object 104 by means of the analog neural network 200 based on the at least one local maximum.

The analog neural network 200 can be trained to determine at least one local maximum based on the accumulated sensor data 124. In particular, due to an iterative adaptation process, the processing of the accumulated sensor data 124 received by the analog neural network 200 can be trained or set such that the analog neural network 200 can effectively learn to recognize relevant features, such as a maximum, in the accumulated sensor data 124 and to make accurate predictions. A training data set for training the analog neural network 200 can comprise sensor data 124, which have local maxima, and corresponding known output data, for example, the known local maxima of the sensor data 124.

The data processing unit 120 can comprise the evaluation unit 130 so that the data processing unit 120 and the evaluation unit 130 form a common signal processing and evaluation unit 140. The data processing unit 120 and the evaluation unit 130 can be arranged on a common chip. In other words, the chip can comprise the signal processing and evaluation unit 140. The chip can have a size in terms of surface area of between 2 mm² and 5 mm², in particular 3 mm².

FIG. 2 shows an exemplary representation of accumulated sensor data 124 in a histogram 150. The histogram 150 shows a number of “hits” in relation to the time of flight of light signals. The histogram 150 represents the measurement of a single target or a single recognized object 104 in the environment of the sensor 110 without the influence of extraneous light. The total number of the hits or of the evaluated reception signals 108 is 2444.

The number of hits is displayed on the y-axis 154 of the histogram 150, while the x-axis 152 of the histogram 150 shows the times of flight of the light signals in bins, wherein a bin can represent a discrete time interval. The number of hits can correspond to the reception signals 108 that were reflected or remitted by an object 104. In particular, in the histogram 150, the number of reception signals 108 is shown in accumulated form for each time of flight.

A clear local maximum 156 can be recognized at a value of approximately “210” of the time of flight on the x-axis 152 of the histogram 150, which indicates a significant accumulation of hits at this value. In other words, approximately 250 reception signals 108 (corresponding value on the y-axis 154 to the local maximum 156 at a value of approximately “210” on the x-axis 152 of the histogram 150) with a time-of-flight value of approximately “210” were evaluated and accumulated.

FIG. 3 shows a further exemplary representation of accumulated sensor data 124 in a histogram 160. Like the histogram 150 from FIG. 2, the histogram 160 likewise represents a number of “hits” in relation to the time of flight of light signals without the influence of extraneous light. However, a single target is not shown in the histogram 160, but rather a double target, for example, of two objects 104 in the environment of the sensor 110 at different distances from the sensor 110. A double target can also occur due to a single object 104, for example, in the case of a reflection of the light signals at a glass pane or in the case of edge hits of an object 104. The total number of hits or of the evaluated reception signals 108 is 4132.

Two local maxima 166, 168 can be recognized at a value of approximately “280” and “420” of a time of flight on the x-axis 162 of the histogram 160, which indicates a significant accumulation of hits at these values. In other words, approximately 190 reception signals 108 (corresponding value on the y-axis 164 to the first local maximum 166 at a value of approximately “280” on the x-axis 162 of the histogram 160) with a time-of-flight value of approximately “280” were evaluated and accumulated and approximately 205 reception signals 108 (corresponding value on the y-axis 164 to the second local maximum 168 at a value of approximately “420” on the x-axis 162 of the histogram 160) with a time-of-flight value of approximately “420” are evaluated and accumulated.

FIG. 4 shows yet another exemplary representation of accumulated sensor data 124 in a histogram 170. Like the histograms 150 and 160 in FIGS. 3 and 4, the histogram 170 likewise represents a number of “hits” in relation to the time of flight of light signals. The histogram 170 shows the measurement of a single target or a single recognized object 104 in the environment of the sensor 110 but with the influence of extraneous light. The total number of the hits or of the evaluated reception signals 108 is 9927.

A local maximum 176 can be recognized at a value of approximately “95” of a time of flight on the x-axis 172 of the histogram 170, which indicates a significant accumulation of hits at this value. In other words, approximately 65 reception signals 108 (corresponding value on the y-axis 174 to the local maximum 176 at a value of approximately “95” on the x-axis 172 of the histogram 170) with a time-of-flight value of approximately “95” were evaluated and accumulated. However, signals were received and evaluated for each time of flight, for each value on the x-axis 172 of the histogram 170. This “noise” can be produced by the influence of extraneous light. An evaluation of the accumulated sensor data 124 can thereby be made more difficult. In particular, the determination of a local maximum 176 can be made more difficult.

The histograms 150, 160, 170 in FIGS. 2 to 4 represent characteristic image sequences of processed sensor data 116, from each of which at least one local maximum 156, 166, 168, 176, and thus a distance of at least one object 104 from the sensor 110, can be determined by means of an analog neural network 200, as described below.

FIG. 5 shows an exemplary schematic diagram of an analog neural network 200. The analog neural network 200 can comprise a plurality of input nodes 202 and a sum node 204. Each input node 202 can be configured to receive the accumulated sensor data 124 or a portion of the accumulated sensor data 124. The sum node 204 can be configured to perform a weighted summation of the accumulated sensor data 124 received via the input nodes 202 in order to determine the at least one local maximum 156, 166, 168, 176 (see FIGS. 2 to 4).

The accumulated sensor data 124 can be converted into analog signals by means of a digital-to-analog converter (DAC) 206. The analog signals can be received by the input nodes 202 of the analog neural network 200 and multiplied by specific weightings 208. The weighted analog signals at the input nodes 202 can be forwarded to the sum node 204 and summed in the sum node 204.

The weightings 208 can determine how strongly the signal of an input node 202 influences an output signal 214. The weightings 208 can be adjusted by a learning process to improve the accuracy of the analog neural network 200 in the filtering of sensor data 116 or in the recognition of patterns in the sensor data 116.

The summed signal is conducted by an activation function 210 to perform a non-linear transformation before said summed signal is converted into the digital output signal 214 by means of an analog-to-digital converter (ADC) 212. The activation function 210 in the analog neural network 200 has the task of applying non-linear transformations to the summed signal.

The activation function 210 can enable the analog neural network 200 to learn and recognize complex patterns or anomalies in the sensor data 116, which can significantly increase the performance. Different activation functions such as Sigmoid, ReLU or Tanh can be adapted to different tasks and data structures. Furthermore, the activation function 210 can amplify or attenuate signals to emphasize relevant features or to reduce noise. Some activation functions 210 can limit the output to a specific region, which can improve the stability of the network.

It is understood that the analog neural network 200 can comprise a plurality of layers, wherein each layer can comprise a plurality of sum nodes 204. These layers can enable the analog neural network 200 to transform information through a plurality of processing planes, which can improve the pattern recognition ability.

The layers can comprise an input layer that receives the sensor data 116 and forwards said data to the analog neural network 200, hidden layers that are responsible for the main processing and that can detect complex patterns in the sensor data 116, and an output layer that provides the final result of the analog neural network 200. A plurality of layers can increase the flexibility and adaptability of the analog neural network 200 so that it can be tailored to specific tasks. Furthermore, a plurality of layers can improve the learning ability of the analog neural network and can enable it to learn from large and complex data sets.

The analog neural network 200 can be configured as a correlation filter or an optimal filter. A signal-to-noise ratio (SNR) can be optimized by means of the correlation filter. In particular, a local maximum can be determined in the accumulated sensor data 124 by checking or comparing similarities of the input variables with predefined patterns. The analog neural network 200 can thus be used to optimally determine the presence of a local maximum in sensor data in the presence of interference, e.g. interfering signals, noise, etc.

As part of a training process, the analog neural network 200 can undergo a plurality of iterations in which the weightings 208 can be optimized step by step. Typically, a backpropagation algorithm is used in which the error is calculated between the predicted output and the actual output. This error is then propagated backwards through the network and the weightings 208 are adjusted so that the error is minimized.

Due to this iterative adjustment process, the weightings 208 can be set so that the analog neural network 200 can effectively learn to recognize relevant features such as a maximum in the accumulated sensor data 124 and to make accurate predictions. The weightings 208 can thus be adjusted by an iterative learning process (in other words, by a “taught” programming) of the analog neural network 200 and can be realized by (e.g. digitally) controlled transistor switches.

A training data set for training the analog neural network 200 can comprise input data and corresponding known output data. The input data can comprise a plurality of histograms 150, 160, 170 comprising accumulated sensor data 124, e.g. the histograms 150, 160, 170 as shown in FIGS. 2 to 4. The input data can also generally comprise sensor data 116 that have local maxima. The known output data can be corresponding known local maxima of the histograms 150, 160, 170 or of the sensor data 116. Different pattern scenarios for an application of the analog neural network 200 for recognizing local maxima (in other words: peak extraction from histograms) can be used or taught in sensor data.

Based on the input data, the analog neural network 200 can produce a result that can then be compared with the known output data. In particular, the local maxima 156, 166, 168, 176 in the output data that are known in the histograms 150, 160, 170 or in the sensor data 116 can be compared with local maxima determined by the analog neural network 200 based on the input data. Based on the result, the parameters, i.e. the weightings 208 of the analog neural network 200, can be adjusted.

The analog neural network 200 is trained or “taught” such that, by means of the analog neural network 200, the local maxima that represent the sought distance values can be extracted quickly from the sensor data with minimal complexity and affordable technology nodes. Furthermore, power losses and latency times can be reduced by the use of the analog neural network 200.

FIG. 6 shows a flowchart 300 that illustrates a method for filtering sensor data according to an embodiment. In step 302, reception signals can be received by means of a sensor after reflection or remission at an object. In step 304, the reception signals can be processed into sensor data by means of a data processing unit. In step 306, the sensor data can be accumulated by means of the data processing unit. In step 308, by means of an evaluation unit, at least one local maximum can be determined by means of an analog neural network based on the accumulated sensor data.

According to an embodiment example, transmission signals can be transmitted by means of the sensor.

According to an embodiment example, a plurality of times of flight between a transmission of the transmission signals and a reception of the reception signals can be determined by means of the data processing unit.

According to an embodiment example, a number of reception signals can be accumulated for each time of flight by means of the data processing unit.

According to an embodiment example, by means of the evaluation unit, the at least one local maximum can be determined by means of the analog neural network based on the number of reception signals for each time of flight.

According to an embodiment example, by means of the evaluation unit, a distance from the object can be determined by means of the analog neural network based on the at least one local maximum.

Each of the steps 302, 304, 306, 308 and the steps described further above can be performed by the system described herein for filtering sensor data.

A system and a method for filtering sensor data as described herein are in particular suitable for an efficient evaluation of histograms in finding relevant information for the optical distance measurement. The system and method for filtering sensor data described herein are in particular suitable for the realization of an application-specific integrated circuit (ASIC) for industrial applications for a distance measurement with typical technology nodes from 100 nm to 350 nm. In particular, an integration of the system described herein for filtering sensor data can be implemented with a small surface-area effort of approximately 3 mm² for a chip and an approximately 180 nm technology node at a <500 10-fold acceleration, wherein a technology node defines an achievable miniaturization level (smallest structure size).

### REFERENCE NUMERAL LIST

100 system for filtering sensor data
102 sensor control unit
104 object
106 transmission signal
108 reception signal
110 sensor
112 transmitter
114 receiver
116 sensor data
118 TDC converter
120 data processing unit
122 histogram unit
124 accumulated sensor data
130 evaluation unit
132 microcontroller
140 signal processing and evaluation unit
150 histogram
152 x-axis
154 y-axis
156 maximum
160 histogram
162 x-axis
164 y-axis
166 maximum
168 maximum
170 histogram
172 x-axis
174 y-axis
176 maximum
200 analog neural network
202 input node
204 sum node
206 digital-to-analog converter
208 weightings
210 activation function
212 analog-to-digital converter
214 output signal
300 flowchart of a method for filtering sensor data
302 step for receiving reception signals
304 step for processing the reception signals into sensor data
306 step for accumulating the sensor data
308 step for determining at least one local maximum by means of an analog neural network

1. A system for filtering sensor data, comprising
a sensor configured to transmit transmission signals and to receive reception signals after reflection or remission at an object;
a data processing unit configured to process the reception signals into sensor data and to accumulate the sensor data, and
an evaluation unit configured to determine at least one local maximum by means of an analog neural network based on the accumulated sensor data.

2. The system according to claim 1,
wherein the analog neural network is configured as a correlation filter.

3. The system according to claim 1,
wherein the analog neural network comprises a plurality of input nodes and a sum node.

4. The system according to claim 3,
wherein each input node of the plurality of input nodes is configured to receive the accumulated sensor data or a portion of the accumulated sensor data, and
wherein the sum node is configured to perform a weighted summation of the accumulated sensor data received via the input nodes in order to determine the at least one local maximum.

5. The system according to claim 1,
wherein the data processing unit is configured to accumulate the sensor data into a histogram.

6. The system according to claim 5,
wherein the histogram is produced by accumulating the sensor data over a predetermined time period, and/or
wherein the histogram is produced by dividing the sensor data into a predetermined number of time intervals, and
wherein the histogram comprises a frequency count based on the sensor data within the predetermined time period and/or within the respective time interval.

7. The system according to claim 1,
wherein the data processing unit comprises the evaluation unit.

8. The system according to claim 1,
wherein the data processing unit and the evaluation unit are arranged on a common chip.

9. The system according to claim 8,
wherein the chip has a size in terms of surface area of between 2 mm² and 5 mm².

10. The system according to claim 1,
wherein the sensor comprises at least one light transmitter for transmitting light transmission signals and at least one light receiver for receiving light reception signals after reflection or remission of the light transmission signals at the object.

11. The system according to claim 1, wherein the data processing unit is configured to determine a plurality of times of flight between a transmission of the transmission signals and a reception of the reception signals and to accumulate a number of reception signals for each time of flight, and
wherein the evaluation unit is configured to determine the at least one local maximum by means of the analog neural network based on the number of reception signals for each time of flight.

12. The system according to claim 1,
wherein the evaluation unit is configured to determine a distance from the object by means of the analog neural network based on the at least one local maximum.

13. A method for filtering sensor data, comprising:
receiving, by means of a sensor, reception signals after reflection or remission at an object;
processing, by means of a data processing unit, the reception signals into sensor data;
accumulating, by means of the data processing unit, the sensor data; and
determining, by means of an evaluation unit, at least one local maximum by means of an analog neural network based on the accumulated sensor data.

14. The method according to claim 13, further comprising:
transmitting, by means of the sensor, transmission signals;
determining, by means of the data processing unit, a plurality of times of flight between a transmission of the transmission signals and a reception of the reception signals;
accumulating, by means of the data processing unit, a number of reception signals for each time of flight;
determining, by means of the evaluation unit, the at least one local maximum by means of the analog neural network based on the number of reception signals for each time of flight; and
determining, by means of the evaluation unit, a distance from the object by means of the analog neural network based on the at least one local maximum.

15. A vehicle comprising a system for filtering sensor data according to claim 1.
